(19) United States
(12) Patent Application Publication
(10) Pub. No.: US 2015/0205869 A1
(43) Pub. Date: Jul. 23, 2015

(54) SYSTEM AND METHOD FOR EFFICIENT SORTING OF RESEARCH PUBLICATIONS AND RESEARCHERS

(71) Applicant: RESEARCHPULSE LLC, NEW YORK, NY (US)

(72) Inventor: DMITRY GREEN, NEW YORK, NY (US)

(21) Appl. No.: 14/598,903

(22) Filed: Jan. 16, 2015

Related U.S. Application Data
(60) Provisional application No. 61/929,552, filed on Jan. 21, 2014.

(51) Int. Cl. G06F 17/30

(52) U.S. Cl. CPC G06F 17/30864; G06F 17/30011

(57) ABSTRACT

A method for responding to a query on a database of publications includes receiving a user query including one or more keywords. A plurality of publications of the database are analyzed to determine a subset of publications that relate to the received keywords. A set of authors is established. The set including all authors credited as having contributed to each publication of the subset of publications. A score is calculated for each author of the set of authors based on information obtained from each publication that credits the author being scored as an author thereof. Query results including a set of top-scoring authors of the established set of authors are provided to the user.

### CROSS-REFERENCE TO RELATED APPLICATION

The present application is based on U.S. Provisional Patent Application Ser. No. 61/929,552, filed Jan. 21, 2014, the entire contents of which are herein incorporated by reference.

### TECHNICAL FIELD

The present disclosure relates to sorting and, more specifically, to efficient sorting of research publications and researchers.

### DISCUSSION OF THE RELATED ART

Scientific, engineering, and medical publications such as manuscripts, journal articles, conference proceedings, academic theses, patent publications and the like play an important role in the dissemination of scientific, technical, medical, economic, sociological, historical, and public policy research and insight. By efficiently disseminating this knowledge around the world, these publications accelerate the advance of discovery and enhance the understanding, lifestyle, and health of people the world over.

However, as the pace of discovery increases, parsing the trove of available publications is becoming more difficult. It is becoming harder to identify those publications, institutions and authors that are most pertinent to a particular field or subfield of science, technology and medicine.

### SUMMARY

A method for responding to a query on a database of publications includes receiving a user query including a name of an author. A plurality of publications accessible by the database of publications is analyzed to determine a subset of publications for which the author named in the received user query is credited as having contributed to. A score for each publication, of the subset of publications for which the author named in the received user query is credited as having contributed to, is calculated. The calculating of the score includes analyzing the plurality of publications accessible by the database of publications to determine a subset of publications that cite to the publication being scored, determining a total number of publications that cite to the publication being scored, as well as a corresponding date of publication for each publication of the subset of publications that cite to the publication being scored, and calculating a score for the publication being scored using the determined total number of publications that cite to the publication being scored and the corresponding dates of publication for the publications of the subset of publications that cite to the publication being scored. Query results including a set of top-scoring publications of the subset of publications for which the author named in the received user query is credited as having contributed to is provided to the user.

Calculating the score for the publication being scored may further include factoring in one or more user-provided ratings for each publication being scored.

Providing the query results to the user may include providing, to the user, an opportunity to rate each of the set of top-scoring publications and storing each user-provided rating.

The user provided ratings for each of the set of top-scoring publications may be used in calculating a corresponding score for each rated publication for use in subsequent iterations of the method for responding to a query.

A method for responding to a query on a database of publications includes receiving a user query including one or more keywords. A plurality of publications accessible by the database of publications is analyzed to determine a subset of publications that relate to the received one or more keywords. A set of authors is established, the set including all authors credited as having contributed to each publication of the subset of publications that relate to the received one or more keywords. A score is calculated for each author of the set of authors based on information obtained from each publication of the plurality of publications accessible by the database of publications that credits the author being scored as an author thereof. Query results including a set of top-scoring authors of the established set of authors are provided to the user.

The calculation of the score for each author may include analyzing the plurality of publications accessible by the database of publications to determine a subset of publications that credit the author being scored as having contributed thereto. A total number of publications that credit the author being scored as having contributed thereto may be determined. For each publication that credits the author being scored as having contributed thereto, a total number of credited authors may be determined. A score is calculated for the author being scored using the determined total number of publications that credit the author being scored as having contributed thereto and the total number of credited authors for the publications of the subset of publications that credit the author being scored as having contributed thereto.

Calculating the score for the author being scored may further include factoring in one or more user-provided ratings for each author being scored.

Calculating the score for the author being scored may further include calculating a score for each of the publications that credits the author being scored as having contributed thereto and increasing the relative influence of those publications, on the author score, that have the highest rating.

Calculating the score for each of the publications may include analyzing the plurality of publications accessible by the database of publications to determine a subset of publications that cite to the publication being scored. A total number of publications that cite to the publication being scored, as well as a corresponding date of publication for each publication of the subset of publications that cite to the publication being scored, may be determined. A score for the publication being scored may be calculated using the determined total number of publications that cite to the publication being scored and the corresponding dates of publication for the publications of the subset of publications that cite to the publication being scored.

Calculating the score for the publication being scored may further include factoring in one or more user-provided ratings for each publication being scored.

A method for responding to a query on a database of publications includes receiving a user query including one or more keywords. A plurality of publications accessible by the database of publications is analyzed to determine a subset of publications that relate to the received one or more keywords. A score for each publication of subset of publications that relate to the received one or more keywords is calculated. Query results including a set of top-scoring publications are provided to the user. The user is provided with an opportunity to rate each of the set of top-scoring publications. The user-provided ratings are used to modify the calculated scores.

The user-provided ratings may include a single quality rating.

The user-provided ratings may include an originality rating and a clarity rating.

Other users may be provided with an opportunity to vote the ratings provided by the user “up” or “down” wherein an “up” vote increases an extent to which the user-provided rating modifies the publication score and a “down” vote decreases the tent to which the user-provided rating modifies the publication score.

Calculating the score for each publication of subset of publications that relate to the received one or more keywords may include analyzing the plurality of publications accessible by the database of publications to determine a subset of publications that cite to the publication being scored, determining a total number of publications that cite to the publication being scored, as well as a corresponding date of publication for each publication of the subset of publications that cite to the publication being scored, and calculating the score for the publication being scored using the determined total number of publications that cite to the publication being scored and the corresponding dates of publication for the publications of the subset of publications that cite to the publication being scored.

Calculating the score for the publication being scored may further include factoring in one or more user-provided ratings for each publication being scored.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a flow chart illustrating an approach for scoring/sorting publications and/or authors in accordance with exemplary embodiments of the present invention;

FIG. 2 is a schematic diagram illustrating a system for performing the approach illustrated in FIG. 1;

FIG. 3 is a flow chart illustrating an approach for generating and maintaining the library of publications 24 and the listing of authors 26 in accordance with exemplary embodiments of the present invention;

FIG. 4 is a schematic diagram illustrating a system for performing the generation and maintenance functionality shown in FIG. 3;

FIG. 5 is a flow chart illustrating an approach for user-assisted author disambiguation in accordance with exemplary embodiments of the present invention;

FIG. 6 is a flow chart illustrating an approach for processing a user's author-based query in accordance with exemplary embodiments of the present invention;

FIG. 7 is a schematic diagram illustrating a system for processing a user's author-based query in accordance with exemplary embodiments of the present invention;

FIG. 8 is an example of a graph that may be displayed as part of the exemplary user interface in accordance with exemplary embodiments of the present invention; and

FIG. 9 shows an example of a computer system capable of implementing the method and apparatus according to embodiments of the present disclosure.

### DETAILED DESCRIPTION OF THE DRAWINGS

In describing exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Exemplary embodiments of the present invention seek to provide a set of tools and techniques for efficiently parsing the immense and rapidly growing library of publications and their authors so that scientists, engineers, academics and others can effectively discover the publications and experts that are most influential to a particular field or subfield of science, technology and medicine.

Exemplary embodiments of the present invention provide a mechanism for grading and/or sorting publications and/or authors by a measure of importance for a given field or subfield. For example, a user wishing to identify a set of top publications in the field of particle physics may utilize exemplary embodiments of the present invention to determine a set of publications that have a greatest level of importance. A user wishing to identify a set of top researchers and theorists in the subfield of quantum chromodynamics may utilize exemplary embodiments of the present invention to see a list of scientists most important to this particular subfield, sorted by scores, which are computed, and/or standard indicators.

The library of publications may include manuscripts, journal articles, conference proceedings, academic theses, patent publications, web pages, and the like. The library of publications may be built by crawling the Internet, connecting with official databases of various jurisdictions, and/or subscribing to one or more proprietary databases. As used herein, the term “author” is used to describe any person credited with contributing to the publication, regardless of whether they were directly involved in drafting the publication. Exemplary embodiments of the present invention utilize various techniques, as will be described in detail below, to assign a score to each publication within the built library as well as to each author for every publication, and to associated organizations, including institutions where the author(s) are based, affiliated funding agencies connected with the publication, and journals in which the publication was published.

Each publication may be categorized in accordance with a hierarchy of fields and subfields. Each publication may be tagged with this field hierarchy within the built library. Thus, a user searching for a particular field may be free to search on a field as broad as, for example, physics, or as narrow as, for example, electroweak bosons. Categorization of the publications may be supplied by the publication itself, the publisher thereof, or the database service providing the publication to the library. Alternatively, categorization may be determined automatically based on, for example, keyword search or other means such as by prior knowledge of the fields of endeavor of the authors for the given publication. It is anticipated that for a given library, the category of some publications may be provided while the category of other publications would be determined or inferred. User input may also be provided to categorize publications. While utilizing user input to categorize all publications within the library may not be practical, according to some exemplary embodiments of the present invention, all publications over a particular threshold level of importance may be presented to a human user for categorization, with the remaining publications receiving only computer-assigned categorization.

When a user performs a query, the user may provide a desired field/subfield and a sub-library of publications may be formed to include all publications of the library that are within the provided field/subfield as well as all subordinate subfields. Each of the publications of the sub-library may then be scored in accordance with various factors such as a number of times any publication within the full library has cited to the particular publication. According to one exemplary embodiment of the present invention, all publications of the library are pre-scanned to identify citations made therein and each identified citation is associated with the cited publication, for example, as metadata. Additionally, a score may be calculated for each publication in the library and this score may be similarly associated with the publication so that at the time of forming the sub-library, each publication thereof may already be assigned a score.

Similarly, when a user performs a query, a subset of authors may be formed to include all authors for all of the publications within the sub-library. Alternatively, or additionally, a set of fields/subfields may be pre-associated with each author of a publication in the entire library and the provided field/subfield may be used to create the subset of authors. Categorization of each author may be performed by analyzing biographical data associated with that author, for example, by crawling government, university and corporate websites or by consulting with a biographical database. In either case, an author may be able to edit his or her fields/subfields via a user portal.

As is the case with publications, a predetermined score may be associated with each author so that at the time of the query, when the sub-library of publications and subset of authors is identified, sorting the publications and authors by importance may be quickly performed by reference to the associated scores. For example, each of the authors of the full library may be pre-scored in accordance with various factors such as a number of publications that author has been credited with having contributed to.

However, exemplary embodiments of the present invention recognize that looking only to the number of times a publication has been cited by other publications may be insufficient to accurately assess the importance of that publication. Similarly, exemplary embodiments of the present invention recognize that looking only to the number of publications an author has been credited as having contributed to may be insufficient to accurately assess the importance of that author. Accordingly, exemplary embodiments of the present invention utilize one or more additional factors in scoring publications and authors.

These additional factors may include an age of the publication, which is defined herein as an amount of time that has elapsed since the publication was originally published. The age of publication may be used in combination with the number of times the publication has been cited in other publications to determine a rate of citation. The rate of citation may then be used either in place of the number of citations in determining a score for a particular publication, or in addition to it and various other factors. In its simplest embodiment, the rate of publication may be calculated as the number of citations divided by the length of time that has elapsed since the publication was published. However, as this approach may tend to over-score especially new publications that have only been cited a few times or under-score older publications that have experienced a recent uptick in citation activity, exemplary embodiments of the present invention may utilize a more sophisticated relationship between number of citations and publication age. According to one such approach, this relationship may be a polynomial function in which total number of citations and rate of citation are both used to an extent that varies depending on the age of publication, with total number of publications being more highly weighted at the extremes of very new and very old.

According to another approach, rather than simply looking at total number of citations divided by publication age, the age of each citation may be determined so that a trend may be detected. Examples of detectable trends may include a high number of citations within a recent window of time such as in the past 12 months, or a recent acceleration in the rate of citation with respect to time. This may be calculated, for example, by plotting citations over time and fitting a curve to the plot using known techniques for curve fitting. The degree to which particular curves fit the data may then be used to determine the publication's score. In this way, and in other ways, the shape of the plot of all citations over time may be used to determine the score of the publication.

This notion that recent increases in rate of citation may be indicative of increased importance may be conceptualized as attributing greater importance to publications that are “trending.” Exemplary embodiments of the present invention may analyze the full library of publications to determine an extent to which the publication is trending. This calculation may be performed for each publication in the library on a periodic basis, for example, daily.

This concept of trending publications may also be applied to publications that are too new to have a significant number of publications that cite to it. For example, social media sources may be monitored to detect citations and links to the given publication and the degree to which a publication is trending may be influenced by these links and citations. This degree to which a publication is trending may factor into the publication's importance score, particularly, and perhaps to a higher degree, for publications that are very new, for example, have been published less than six months ago.

Similarly, in scoring the authors, the total number of credited authors per publication may be used to qualify the number of publications an author is credited for. For example, being an author of a publication with a great many credited authors may matter less than being an author of a publication with a small number of credited authors on the assumption that authorship is more significant when there are fewer authors. Conversely, on the assumption that publications with a greater number of authors are more important than publications having fewer authors, being an author of a publication with more authors may increase author score more than being an author of a publication with fewer authors.

Additionally, it need not be assumed that all citations are of equal value in assessing author score. For example, a citation in a higher scored publication may increase author score more than a citation in a lower scored publication. Moreover, since additional factors may be used to assess publication score, these additional factors may indirectly influence author score. For example, the prestige of the publishing journal may factor into the score of the publication in two ways: first, publications appearing in more prestigious journals may receive higher scores, and second, a citation from a publication from a more prestigious journal may have a greater influence on score than a citation from a publication from a less prestigious journal.

According to one exemplary embodiment of the present invention, a prestige rating may be assigned to each publication based on the journal it was published in and in determining the score of a particular publication, citations-by-prestige-rating may be plotted against age of citation so that trends such as an increase in the prestige of citation sources may be identified.

As discussed above, the user who initiated the query may receive, as a response to the query, a listing or scoring of highest scoring publications and/or authors restricted to the specific field/subfield of the query. Additionally, the user may be provided with one or more plots showing citations with respect to age, for top-scoring publications and/or one or more plots showing number of authorships with respect to total number of authors for each given publication, for top-scoring authors. The user may, in this way, gain a better sense of the relative importance of authors and publications.

As described above, the author score may be calculated based on the number of papers that the author is credited as authoring and the score of the publications in which the citations are found in. Moreover, as described above, query results may be limited to top-scoring publications that satisfy a particular flied/subfield. Top-scoring authors may be similarly limited by field/subfield by calculating author scores exclusively or primarily based on citations from publications of the particular field/subfield.

In all cases it may be important for the user to be able to assign a rating to each publication that is returned in response to any query. This rating may be incorporated into calculating the publication score, and through aggregation of publication scores, for example, as described in the formulas below) into author and institution scores. Where the user is one of the authors, the ratings assigned by the user/author who themselves have high ratings (and/or high citation or altmetrics scores) may carry a higher weight when computing the average rating of an author, publication, or institution, as compared to the ratings given by users who are not authors or user/authors whose scores are not particularly high.

Exemplary embodiments of the present invention may utilize these user ratings as a complement to or a substitute for traditional peer review processes in which several people who are deemed to be experts in a given field are tasked with reviewing the quality of a given publication. This peer review process generally takes from between three to six months, although peer review may take substantially longer. Publication for the papers undergoing peer review may be delayed during this time. Additionally, conventional peer review processes may be performed manually and may be quite laborious and expensive with back-and-forth between the author, reviewers, and publishing journal which coordinates and administers the process.

The paper under peer review is considered to have a “pre-print” status, which, as described herein, may last for a year or more. During this time, the paper is generally not made publically available, thereby slowing down the dissemination of potentially valuable information. Similarly, as exemplary embodiments of the present invention may involve rating a publication, at least in part, based on citations thereto from other publications, delays in the publication of citing papers attributable to the peer review process may have the consequence of influencing the score of other publications.

Exemplary embodiments of the present invention may accordingly use user ratings to streamline the peer review process, as well as to add more potential peer reviewers, thereby providing a potentially faster and more accurate reviewing model than the traditional peer review model.

Exemplary embodiments of the present invention may permit users to assign ratings to either pre-print or post-publication papers. The ratings may have any desired degree of complexity, however, for the purposes of providing a simplified explanation, the ratings may include the granting of a score of between one and five stars. The score may be an overall score for the significance of the paper (e.g. paper quality) or scores may be granted for multiple categories. According to one exemplary approach, the user may provide a rating for two dimensions of impact: originality and clarity. The number and description of the categories may depend on the field of endeavor.

In order to ensure that the ratings are meaningful, exemplary embodiments of the present invention may utilize various basic controls, for example, users might be prevented from rating publications that they are credited as having authored and/or prevented from rating publications submitted by authors from institutions that they are affiliated with.

According to another example, ratings which are assigned by users who themselves have high ratings, or more traditional measures such as citations, might be weighted more highly.

Another controlling method may provide a user with the ability to vote on a rating submitted by another user, for example, to provide an up- or down-vote to a given other user's ratings (e.g., reputation ranking). These votes may be incorporated into the weighting of user's ratings.

According to some exemplary embodiments, ratings may generally remain anonymous, although they may be displayed in certain circumstances.

User assigned ratings may be stored, for example, as metadata associated with the rated publication/author/institution within the appropriate library/list (e.g. the library of publications or listing of Authors). When calculating the score for a given publication, the system may retrieve these stored user ratings and incorporate them into the publication/author/institution score. For example, instead of using citation count for a given paper i (NCi), the formula may use NCi*f(Rating-i), where f(Rating) is a polynomial or other algebraic function of Rating.

The system may aggregate the score, which includes the paper ratings, at Author- or Institution-level as described herein.

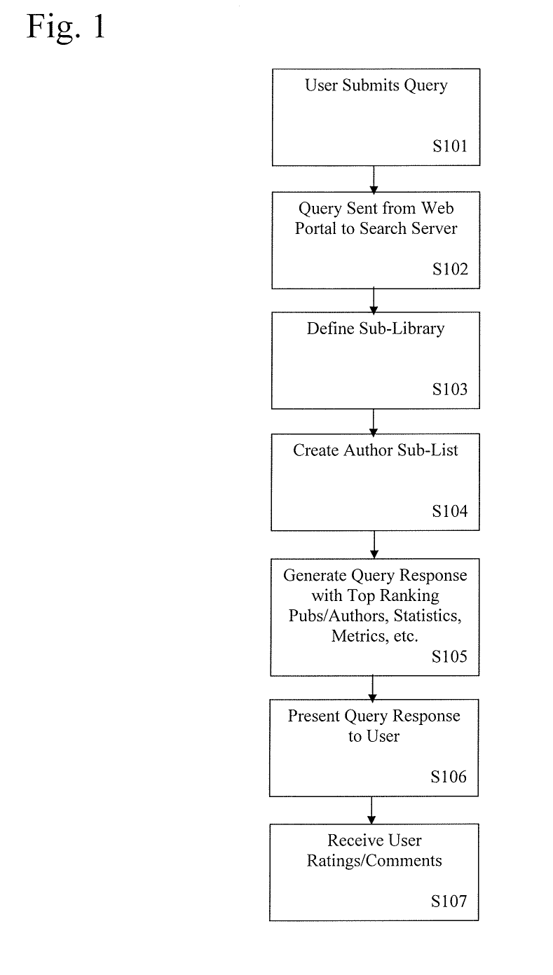

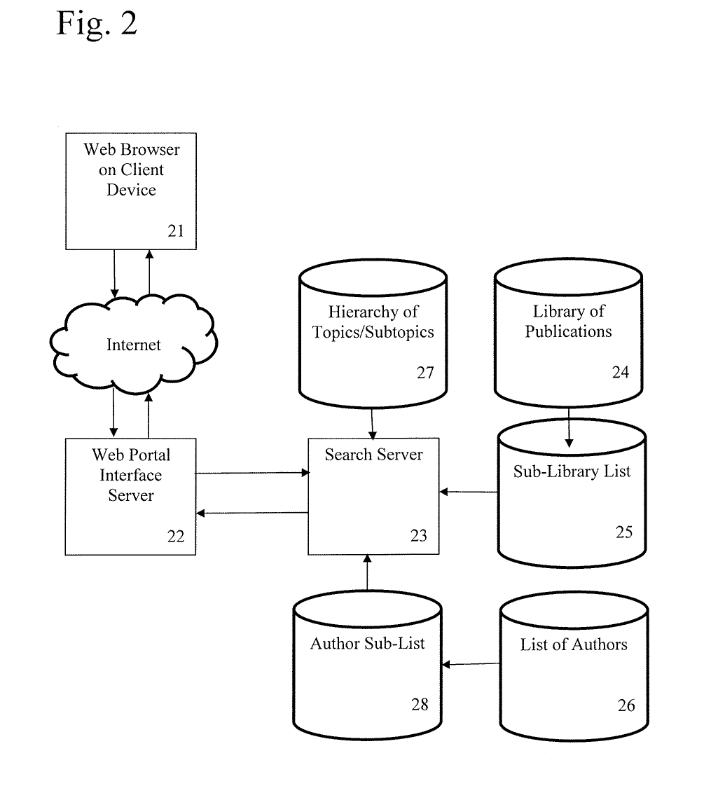

FIG. 1 is a flow chart illustrating an approach for scoring/sorting publications and/or authors in accordance with exemplary embodiments of the present invention. FIG. 2 is a schematic diagram illustrating a system for performing the approach illustrated in FIG. 1. First, a user may submit a query (Step S101). The user may submit the query by using a web browser on a computer or mobile device 21 to access a web portal interface server 22, for example, over the Internet. The user's query may include a topic/subtopic selection. The topic/subtopic selection may be selected by the user from a set of predefined topics/subtopics. Alternatively, the user may enter a new topic/subtopic.

The web portal interface server 22 may provide the user's selected topic/subtopic to a search server 23 (Step S102). The search server 23 may access a library of publications 24 and define a sub-library list 25 therefrom (Step S103). The library of publications 24 may be a publication database including, to the greatest extent possible, every available publication related to scientific, technical and medical fields of endeavor. The library of publications 24 may either store the text of each publication or may include merely a listing of each publication, as described in greater detail below. Construction and administration of the library of publications 24 is also described in greater detail below.

Each of the publications in the library of publications 24 is pre-scored, as described in detail above, and each author of each publication in the library of publications 24 is also pre-scored, as described in detail above. A listing of all credited authors of the publications of the library of publications 24, along with their respective scores, may be maintained in a separate listing of authors 26. Each publication in the library of publications 24 may have one or more associated topics/subtopics and similarly, each author in the listing of authors 26 may have one or more associated topics/subtopics.

A hierarchy of topics/subtopics 27 is also maintained. This hierarchy includes all available topics/subtopics and shows their structure of subordination.

In defining the sub-library list 25 (Step S103), the search server 23 locates the selected topic/subtopic from the hierarchy of topics/subtopics 27 and identifies all subordinate subtopics for the selected topic/subtopic. Then, the library of publications 24 is searched to determine all publications therein that are tagged as either the selected topic/subtopic or any of the subtopics subordinate thereto. The identification of each such publication is added to the sub-library list 25.

An author sub-list 28 is created (Step S104) by either (1) identifying all credited authors for all the publications of the sub-library list 25, or (2) identifying all authors of the listing of authors 26 that have been associated with the selected topic/subtopic and the subtopics subordinate thereto.

The search server 23 may then generate a query response that includes the sub-library list 25 (including the names of the publications therein and their associated scores) and the author sub-list 28 (including the names of the authors therein and their associated scores) (Step S105). The sub-library list 25 and the author sub-list 28 need not be included in the query response in their entirety. For example, the query response may include a set of top-ranking publications from the sub-library list 25 and a set of top-ranking authors from the author sub-list 28.

The web portal interface server 22 may then present the query response to the user (Step S106). The presentation of the query response may include the top-ranking publications from the sub-library list 25 and the top-ranking authors from the author sub-list 28, for example, with these results being displayed in their order of importance. The associated scores may or may not be displayed. The web portal interface server 22 may thereafter provide the user with an opportunity to narrow the field/subfield of the query or to generate a new query. The user may also be provided with an opportunity to retrieve the full text of the top-ranking publications, see the citations to the top-ranking publications in their respective contexts, see the full texts of the publications that have been authored by the top-ranking authors, and/or to see analysis and graphs involved with determining the ranking of the publications and authors.

Additionally, the web portal interface server 22 may receive, from the user, a rating and/or comments regarding the importance of each publication presented as part of the query response (Step S107). These ratings/comments may be associated with the respective publications within the library of publications 24 and may be used to modify the score for the publications. For example, these ratings/comments may be stored as metadata associated with each publication and the computation of scores for both publications and authors may take into account these ratings, where they are available.

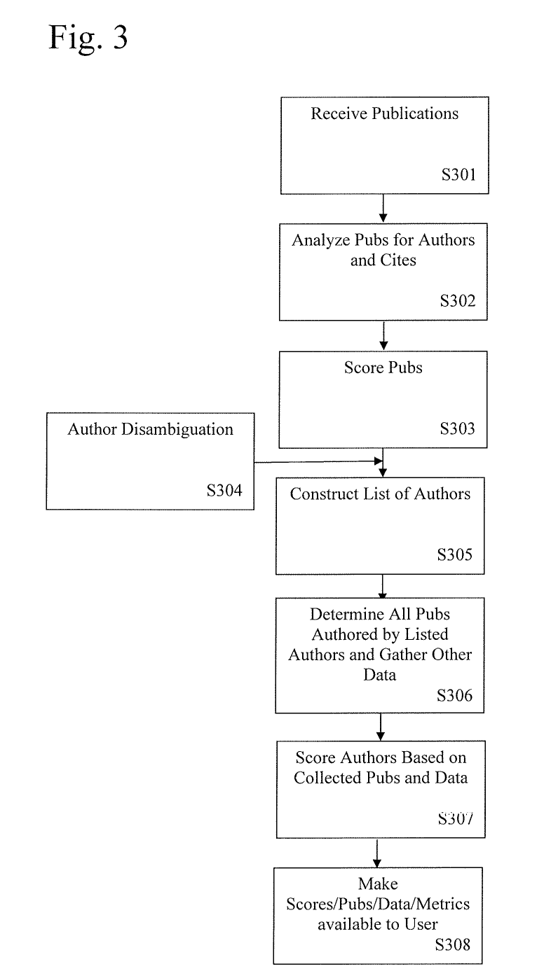

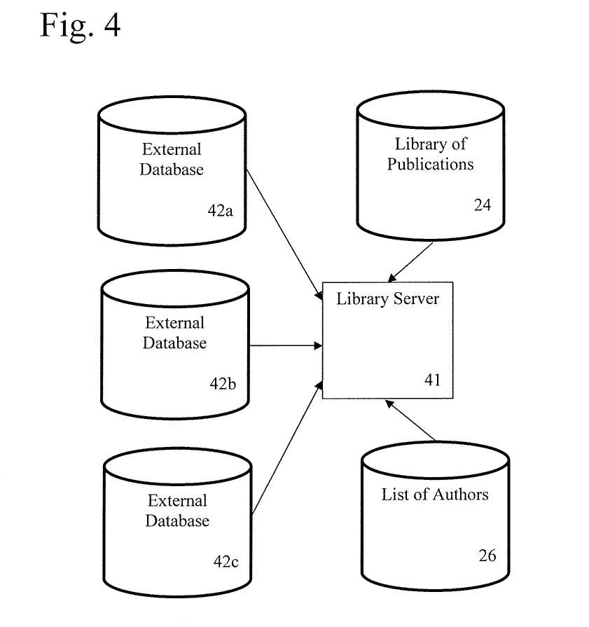

FIG. 3 is a flow chart illustrating an approach for generating and maintaining the library of publications 24 and the listing of authors 26 in accordance with exemplary embodiments of the present invention. FIG. 4 is a schematic diagram illustrating a system for performing the generation and maintenance functionality shown in FIG. 3. It is to be understood that even though the instant application describes this process as separate and apart from the process of answering user queries, the steps described herein may be performed on-the-fly in response to a particular user query.

A library server 41 may receive publications from a plurality of database services 42a, 42b, 42c (Step S301). Reception of the publications may be performed periodically or as the publications are published. The plurality of database services 42a, 42b, 42c may be accessed by the library server 41 using sets of stored credentials. It is to be understood that the operator of the library server 41 may maintain subscriptions to the plurality of database services.

Each of the publications, so received, may be analyzed to identify a field/subfield, a set of credited authors, and a set of citations to other publications that may or may not be part of the library of publications 24 (Step S302). This analysis may optionally further include identification of a prestige score associated with a publisher of the publication, as described above. A table of publishers and corresponding prestige scores may be maintained by the library server 41 for this purpose. Field/subfield, credited authors, and/or citations may be supplied by the respective database service, may be tagged in the publication, or may be inferred by keyword analysis. The field/subfield and credited authors data so-identified may be associated with the respective publication, for example, as metadata. However, an indication of the identified citations may be associated and stored with the cited publication, assuming that it is already within the library of publications 24. This indication may include the prestige score of the citing document, where available, as well as the date of publication of the citing document.

The library server 41 may score each of the publications and associate its score with the publication, for example, as metadata (Step S303). The scoring of each publication may be performed based on factors such as the number of times another publication has cited to the publication, the date that the citing publication was published, the prestige score of the citing publication (where available) and a time/date of query. The time/date of query may be a date approximately equal to the date in which the query was generated. As this scoring may be performed in advance of the generation of the actual query, the score associated with each publication may be stored as a date-dependent function so that score may be determined at the time of query. Alternatively, scores may be updated regularly using a date of the updating as a proxy for the time/date of query. However, according to some exemplary embodiments of the present invention, scoring occurs in real-time in response to a particular query.

Exemplary approaches for calculating publication score are provided in greater detail below.

After the credited authors are identified for a given publication, the library server 41 may add each of the credited authors to the listing of authors 26, assuming the authors are not already in the listing of authors 26 (Step S305). Author disambiguation may be performed before authors are added to the list to ensure that differences in the way author names may be presented do not result in the same author being listed twice or two different authors being treated as the same author (Step S304).

As each credited author is added to the listing of authors 26, an indicia of authorship may be associated with the particular author's entry in the listing of authors 26 (Step S306), for example, as metadata. Where the author is already listed in the listing of authors 26, the indicia of authorship may be associated with the preexisting entry. The indicia of authorship may include the date of publication of the citing publication, the field/subfield of the publication, and its prestige score, where available. The indicia of authorship may additionally include the total number of credited authors for the particular citation, for example, as described above.

The library server 41 may use all such stored indicia of authorship to assign a score for each author within the listing of authors 26 (Step S307). This scoring of authors may be performed: (1) as each new publication is added to the library, (2) periodically, or (3) in real-time in response to a particular query.

Exemplary approaches for calculating author score are provided in greater detail below.

The library server 41 may make the library of publications 24 and the listing of authors 26 available to the search server 23 (Step S308) for use in replying to queries.

The library server 41 need not maintain the actual publications within the library of publications 24. The publications themselves may remain accessible via the plurality of database services 42a, 42b, . . . , 42c while the library of publications 24 may include a listing of each publication along with the publication score and the other data described above. Then, in the event that the user, upon viewing the query results, decides to view the content of one of the publications, the actual publication may be retrieved directly from the appropriate database service. Moreover, in analyzing each publication, the content of the publication may be retrieved from the appropriate database service but the content of the publication need not be stored within the library of publications 24. Alternatively, the content of the publication may indeed be saved within the library of publications 24.

The author disambiguation mentioned above may be performed either automatically or with the input of a user. The user providing this input may be the same user that initiates the query or it may be a different user. In the case of automatic disambiguation, one or more machine learning algorithms or a set of logical constraints may be used to determine whether two similar author names refer to the same or different authors.

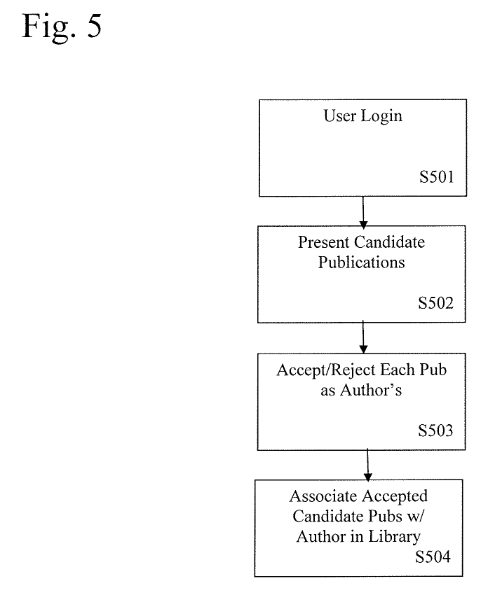

FIG. 5 is a flow chart illustrating an approach for user-assisted author disambiguation in accordance with exemplary embodiments of the present invention. First, a user may log into the system, for example, through a web portal (which may be the same web portal interface server 22 discussed above) (Step S501). While the user may be the same user who runs the queries discussed above, according to some exemplary embodiments of the present invention, the user may be an author who is logging into the system for the purpose of disambiguating himself. Then, the system may query and display all publications from the library of publications 24 that have a credited author whose name is or could be that of the user who logged in or otherwise the author being disambiguated (Step S502). These publications may be referred to herein as candidate publications as it is not yet known for certain which are authored by the user/author being disambiguated. For example, where the user/author is “Dmitry Green,” candidate publications may be all of those publications of the library of publications 24 that have a credited author listed as “Dmitry Green,” “D. Green,” or the like. The user may then review the candidate publications to accept or reject each of them as having been authored by the user/author (Step S503). The set of accepted candidate publications may thereafter be associated with the author within the library of authors 26 (Step S504) so that scoring of the authors may be more accurately based on disambiguated authors. Alternatively, a separate author disambiguation mapping may be maintained for use in scoring.

Various different approaches may be used to score the publications/authors and perform the queries described above. Described below are several exemplary approaches.

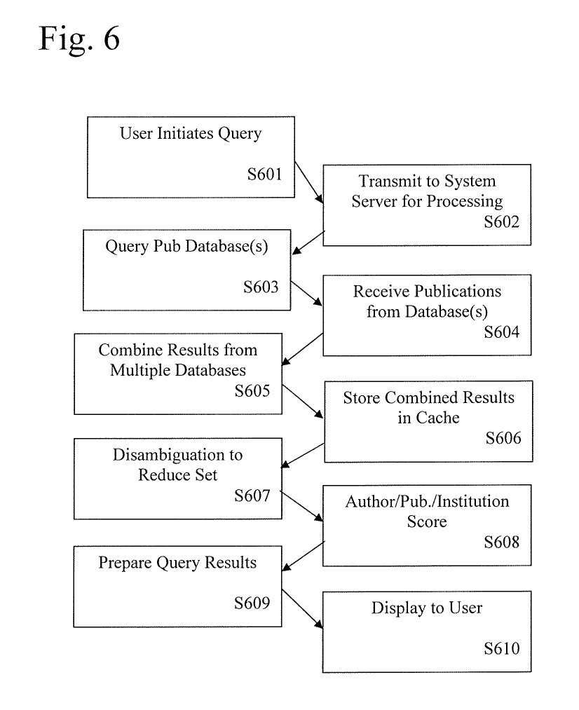

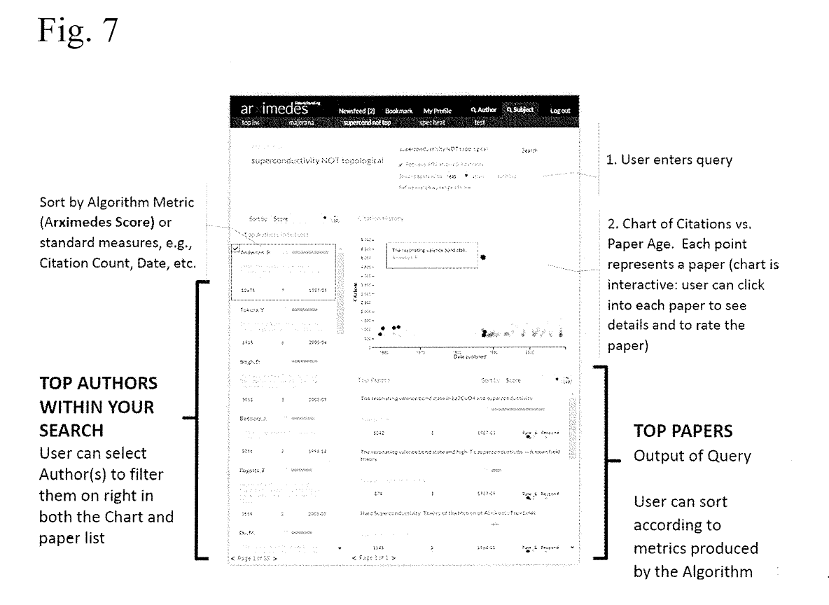

Exemplary embodiments of the present invention have been described above mainly in terms of pre-scoring authors and publications. However, some exemplary embodiments of the present invention score authors and publications in response to a user query. FIG. 6 is a flow chart illustrating an approach for processing a user's author-based query in accordance with exemplary embodiments of the present invention. FIG. 7 is a schematic diagram illustrating a system for processing a user's author-based query in accordance with exemplary embodiments of the present invention.

To initiate the query, a user may send a query through a web-based user-interface 70 (Step S601). The query may include the name of an author. The query may then be transmitted from the web-based user interface 70 to a System Server 71 for query processing (Step S602). The System Server 71 may thereafter query a database of publications for all publications that credit the author named by the user (Step S603). In so doing, the System Server 71 may query a System Database 72, maintained as part of the system disclosed herein, and/or one or more external databases 73, which may be maintained by a third party, for example, as part of a subscribed-for service. In response to these queries, the System Server 71 may receive from the databases 72/73 all publications, or access to all publications, to be found within the databases 72/73, that credit the named author (Step S604). Where results are obtained from both the local System Database 72 and external database(s) 73, these results may be combined into a single subset of publications attributed to the author being searched for (Step S605). This combined publication subset may then be stored within a System Cache 74 (Step S606). Thereafter, the System Server 71 may reduce the combined publication subset by performing author disambiguation, for example, as discussed above, and excluding from the subset, those publications that are no longer believed to have been authored by the author being searched for (Step S607). Of course author disambiguation may be performed prior to querying the various databases in Step S603, however, as the publications themselves may be used to aid author disambiguation, the step of author disambiguation may be performed after the retrieval and combining of the publications, as described. The reduced combined publication subset may be stored in the system cache 74.

The System Server 71 may thereafter perform author scoring (Step S608) for the searched for author, based on the reduced-combined publication subset stored in the system cache 76. Exemplary approaches for author scoring are provided herein. After author scoring has been performed, the System Server 71 may prepare query results, including the calculated author score as well as one or more of the publications and data that were used in calculating this score (Step S609). The prepared query results may then be sent to the web-based user interface 70 for presentation to the user (Step S610).

Various data may be used to perform author scoring. This data may include: (1) a bibcode, or other universal identifier for each publication of the subset, (2) ORCID id of the author, when available, (3) a date of publication for each publication in the subset, (4) a title of each publication, (5) a full listing of all co-authors credited for each publication of the subset as well as (7) an institution of affiliation for each co-author, (8) a number of citations found within each publication of the subset, (9) a full list of all publications that cite to each citation of the publications in the subset (this list may be long and may include the identifiers, e.g. bibcodes, of hundreds of other publications) (it may be necessary to conduct another query of the databases 72/73 to obtain this list), (10) a listing of authors for each publication that cites to the publications of the subset, and (11) a normalized citation count calculated separately for each publication, the normalized citation count being defined as the total number of citations within each publication divided by the total number of authors for that respective publication (this may be calculated for each publication of the subset as well as for each publication that has been found to cite to the publications of the subset.

Rather than searching by author, a user may initiate a query based on one or more key words. In this case, the user may provide one or more search terms and the system may build the subset of publications around those publications found within the databases 72/73 that have a best match to the search terms. This quality of match may also be considered a score and thus another factor that may be considered in the calculation of the author score is (12) the score of how well each publication corresponds to the keywords.

Additionally, various other factors may be considered in scoring the author such as (13) other citation metrics, e.g. mentions in social media (altmetrics) and (14) user-assigned ratings for each publication.

It is to be understood that in calculating the author score, one or more of the 14 factors mentioned above may be considered. While the present inventive concept is not limited to any one particular approach for factoring in one or more of these 14 factors, exemplary approaches for scoring authors and publications using these factors are provided below:

Exemplary approaches may be used to compute a score for each publication (“paper”) returned by the query (“Paper_Score”), a score may be calculated for each author (“Author_Score”) who appears in each of the publications, and a score for each institution (“Instition_Score”) for all institutions that are credited in the papers.

In performing these score calculations, the following variables may be used:

$$\{ {p}_{i} \} = set of papers , where i = 1 , … , {N}_{p} and p = Number of Papers , including titles and abstracts . \\ \{ {A}_{i}^{( j )} \} = set of authors , where i = 1 , … , {N}_{p} and j = 1 , … , NA , NA = Number of distinct authors in the set \{ {p}_{i} \}$$

$$\{ {INS}_{i}^{( k )} \} = set of institutions credited , where i = 1 , … , {N}_{p} , k = 1 , … , NINS . \\ NINS = Number of distinct institutions credited in the set of papers \{ {p}_{i} \}$$

$${NC}_{i} = Number of citations to paper {p}_{i} . \\ {Y}_{i} = Number of years since publication of paper {p}_{i} , expressed as a fraction . \\ {NA}_{i} = Number of authors on paper {p}_{i} . \\ {S}_{i} = Score of paper {p}_{i} . How well paper i matches the search . Top score = 100.$$

It should be noted that the total number of inputs may be on the order of a product of number of papers×number of authors per paper, which may be tens of thousands of data elements for a typical scientific discipline. For example, this number may be calculated as:

$$3 \cdot {\sum }_{i = 1}^{{N}_{p}} ( {NA}_{i} + {NINS}_{i} ) .$$

As described above, exemplary approaches may be used to compute a score for each publication (“paper”) returned by the query (“Paper_Score”). A lower limit for this score may be established so that no publication would receive a score of zero. This lower limit (“floor”) on paper score may be set as a long-term average of citations per paper per author (typically around 5), and can be adjusted as follows:

$${NC}_{i}^{floor} = MAX ( \frac{floor}{{NA}_{i}} , {NC}_{i} ) if {Y}_{i} < 1 , else {NC}_{i}^{floor} = {NC}_{i} \qquad ( eqn . 1 )$$

Additionally, the publication age may be scaled. Typically the number of citations to a paper increases exponentially with paper age, so a typical value for exp=−0.75. However, this is a parameter than can be tuned depending on the scientific discipline, for example:

Y^{scale}ᵢ=MAX(floor,floor·Y^{exp}ᵢ) (eqn.2)

The Paper_Score may be computer for each paper p, which normalizes for citation rate of each paper (e.g., normalize for the age of each paper). All else being equal, a more recent paper with more citations may be viewed as having more impact:

$${PaperScore}_{i} = ( \frac{{S}_{i}}{100} ) \cdot ( \frac{{NC}_{i}^{floor}}{{Y}_{i}^{scale}} ) \qquad ( eqn . 3 )$$

An Author_Score_per_Paper, which incorporates the number of co-authors per paper (generally, the number of citations increases as the number of authors per paper increases, all else being equal) may be computed. This score may be applied to each co-author on the paper p.

Parameters a,b: fit to underlying data depending on discipline, e.g., a=0.6,b=1.5

Normᵢ=MIN(a+b,floor)/(a·NAᵢ+b)

AuthorScorePerPaper^{(j)}ᵢ=PaperScoreᵢ/Normᵢ, where j=1, . . . ,NA (eqn.4)

The Author_Score may be computed for each Author^{(j)}. First, the set of papers {pᵢ} may be restricted to the universe of papers {p^{(j)}ᵢ} which includes only those papers which include Author A^{(j)} as one of the co-authors (or as a single author):

$${AuthorScore}^{( j )} = {\sum }_{i = 1}^{{N}_{i}^{( j )}} {AuthorScorePerPaper}_{i}^{( j )} , \\ where {N}_{i}^{( j )} = number of papers in set \{ {p}_{i}^{( j )} \} . \qquad ( eqn . 5 )$$

The Institution_Score may be computed for each Institution INS^{(k)}, first compute the Institution_Score_per_Paper, in a ‘similar way to Author_Score_per_Paper (eqn.4):

$$\begin{matrix}{InstitutionScorePerPaper}_{i}^{( k )} = {PaperScore}_{i} \text{/} {Norm}_{i} , where k \\ = 1 , … , NINS\end{matrix}$$

The set of papers {pᵢ} may be restricted to the universe of papers {p^{(k)}ᵢ} which includes only those papers where institution INS^{(k)} is credited at least once, e.g., through the affiliation of the co-author(s).

InstitutionScore^{(k)}=Σᵢ₌₁^{N(k)}^{ᵢ}n^{(k)}ᵢ·InstitutionScorePerPaper^{(k)}ᵢ, (eqn.6)
where N^{(k)}ᵢ=number of papers in set {p^{(k)}ᵢ},
and n^{(k)}ᵢ=number of times institution k is credited on paper i

The Institution_Score calculation may also apply to other entities credited in papers {pᵢ}, for example funding agencies and/or grants. This may be used to assess the impact of these entities within the universe of papers {pᵢ}.

According to some exemplary embodiments of the present invention, instead of using citations to each paper as one of the weights for the importance, NCᵢ in (eqn.1), the users may choose one or more of the following alternatives:

(1) User-generated ratings: assigned by users to papers within this system. The user-generated rating may include a reputation rank where ratings assigned by users who themselves have a high number of citations and ratings get a higher weight. For example:

NCᵢ→(average rating of each paper)·NC^{a}ᵢ,

where a is an exponential parameter determined by the subject, e.g. =0.5.

(2) Altmetrics: may include a total number of mentions of the paper/publication on social networks (e.g. TWITTER or FACEBOOK).
(3) Page Rank: an alternative way to count citations is an extension of a page rank approach, where each paper/publication is treated as a web page and citations are treated as links. According to this approach, the citation rank may be used in place of NCᵢ.

The normalization of time since publication, for example, as measured in years, may be tailored to each discipline, for example physics may use an exponent of −0.75 while biology may use −0.5 (eqn.2).

According to one exemplary embodiment of the present invention, a user may search for a particular author by inputting a name of the author. The results of this search may include a listing of all publications in which the searched-for author has been credited as an author of A set of computed statistics associated with that author may also be returned as part of the search results.

FIG. 7 is an exemplary user interface that may be provided by the Web Portal Interface Server in accordance with exemplary embodiments of the present invention. As may be seen herein, a user may use dialog boxes and/or drop-down menus to enter a query such as author search and/or publication search, for example, as described in detail above. The search query may include keywords and one or more logical operators (e.g. “NOT” as shown). The user may also be provided with an opportunity to provide search modifiers such as whether to retrieve affiliations and abstracts, whether to show papers with a particular number of authors or less/more than the particular number of authors. The user may also select to refine the search by a range of time. Other search options and/or modifiers may be selected as well.

The same user interface may also be used to display, to the user, the query results. These results may include a chart of citations with respect to publication age. In such a chart, each point may represent a single publication. The charts may be interactive and accordingly, the user may be able to modify/recreate the chart or the user may select a particular point to drill down into the specific corresponding publication to see the text and/or other details of that publication, to rate the publication, and/or to see and change various other details.

The displayed query results may also include particulars concerning one or more top-scoring publications, which the user may be able to sort in accordance with one or more desired attributes or metrics such as those described above. While an initial display of top-scoring publications may be limited to several (for example, three) publications, the user may be able to scroll through additional results, as desired).

Similarly, the displayed query results may also include particulars concerning one or more top-scoring authors. Again, the user may be able to sort, filter, and/or scroll these results, as desired. According to one exemplary embodiment of the present invention, changes made to the sorting and parameters of the displayed top-scoring publications/authors may influence the arrangement of the displayed chart.

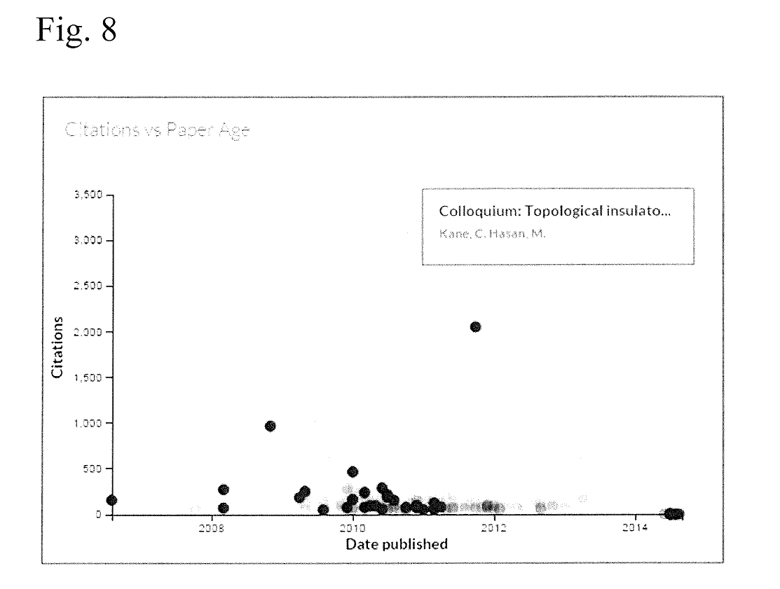

FIG. 8 is an example of a graph that may be displayed as part of the exemplary user interface, as described above. This graph may show citations (y-axis) by publication age (x-axis). As discussed, the displayed graph may be interactive, with the user having the ability to select a desired point to retrieve particulars concerning a corresponding publication and/or to submit a rating. A user may also be able to have highlighted publications that contain a given author, for example, by having dark circles drawn around those data points on the graph. Other publications of interest may be similarly highlighted on the user's providing of criteria for the highlighting.

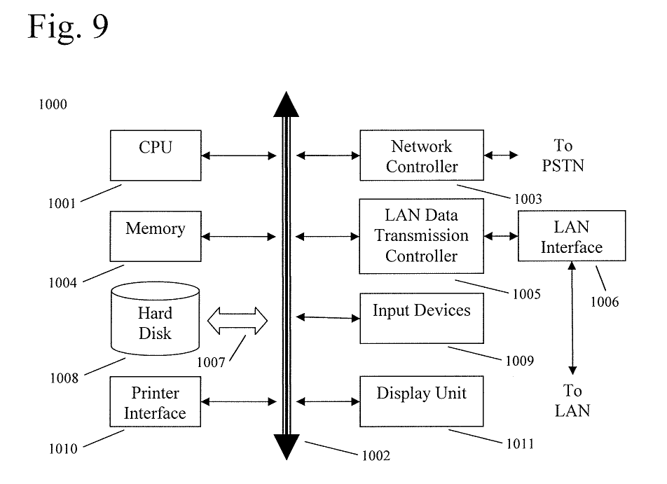

FIG. 9 shows an example of a computer system which may implement a method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

Exemplary embodiments described herein are illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims.

What is claimed is:

1. A method for responding to a query on a database of publications, comprising:
receiving a user query including a name of an author;
analyzing a plurality of publications accessible by the database of publications to determine a subset of publications for which the author named in the received user query is credited as having contributed to;
calculating a score for each publication of the subset of publications for which the author named in the received user query is credited as having contributed to, the calculating of the score including:
analyzing the plurality of publications accessible by the database of publications to determine a subset of publications that cite to the publication being scored;
determining a total number of publications that cite to the publication being scored, as well as a corresponding date of publication for each publication of the subset of publications that cite to the publication being scored; and
calculating a score for the publication being scored using the determined total number of publications that cite to the publication being scored and the corresponding dates of publication for the publications of the subset of publications that cite to the publication being scored; and
providing, to the user, query results including a set of top-scoring publications of the subset of publications for which the author named in the received user query is credited as having contributed to.

2. The method of claim 1, wherein calculating the score for the publication being scored further includes factoring in one or more user-provided ratings for each publication being scored.

3. The method of claim 1, wherein providing the query results to the user includes providing, to the user, an opportunity to rate each of the set of top-scoring publications and storing each user-provided rating.

4. The method of claim 3, wherein the user provided ratings for each of the set of top-scoring publications is used in calculating a corresponding score for each rated publication for use in subsequent iterations of the method for responding to a query.

5. A method for responding to a query on a database of publications, comprising:
receiving a user query including one or more keywords;
analyzing a plurality of publications accessible by the database of publications to determine a subset of publications that relate to the received one or more keywords;
establishing a set of authors including all authors credited as having contributed to each publication of the subset of publications that relate to the received one or more keywords;
calculating a score for each author of the set of authors based on information obtained from each publication of the plurality of publications accessible by the database of publications that credits the author being scored as an author thereof; and
providing, to the user, query results including a set of top-scoring authors of the established set of authors.

6. The method of claim 5, wherein the calculation of the score for each author including:
analyzing the plurality of publications accessible by the database of publications to determine a subset of publications that credit the author being scored as having contributed thereto;
determining a total number of publications that credit the author being scored as having contributed thereto;
determining, for each publication that credits the author being scored as having contributed thereto, a total number of credited authors; and
calculating a score for the author being scored using the determined total number of publications that credit the author being scored as having contributed thereto and the total number of credited authors for the publications of the subset of publications that credit the author being scored as having contributed thereto.

7. The method of claim 5, wherein calculating the score for the author being scored further includes factoring in one or more user-provided ratings for each author being scored.

8. The method of claim 5, wherein calculating the score for the author being scored further includes calculating a score for each of the publications that credit the author being scored as having contributed thereto and increasing the relative influence of those publications, on the author score, that have the highest rating.

9. The method of claim 8, wherein calculating the score for each of the publications includes:
analyzing the plurality of publications accessible by the database of publications to determine a subset of publications that cite to the publication being scored;
determining a total number of publications that cite to the publication being scored, as well as a corresponding date of publication for each publication of the subset of publications that cite to the publication being scored; and
calculating a score for the publication being scored using the determined total number of publications that cite to the publication being scored and the corresponding dates of publication for the publications of the subset of publications that cite to the publication being scored.

10. The method of claim 9, wherein calculating the score for the publication being scored further includes factoring in one or more user-provided ratings for each publication being scored.

11. A method for responding to a query on a database of publications, comprising:
receiving a user query including one or more keywords;
analyzing a plurality of publications accessible by the database of publications to determine a subset of publications that relate to the received one or more keywords;
calculating a score for each publication of subset of publications that relate to the received one or more keywords;
providing, to the user, query results including a set of top-scoring publications;
providing, to the user, an opportunity to rate each of the set of top-scoring publications; and
using the user-provided ratings to modify the calculated scores.

12. The method of claim 11, wherein the user-provided ratings include a single quality rating.

13. The method of claim 11, wherein the user-provided ratings include an originality rating and a clarity rating.

14. The method of claim 11, wherein other users are provided with an opportunity to vote the ratings provided by the user “up” or “down” wherein an “up” vote increases an extent to which the user-provided rating modifies the publication score and a “down” vote decreases the tent to which the user-provided rating modifies the publication score.

15. The method of claim 11, wherein calculating the score for each publication of subset of publications that relate to the received one or more keywords, comprises:
analyzing the plurality of publications accessible by the database of publications to determine a subset of publications that cite to the publication being scored;
determining a total number of publications that cite to the publication being scored, as well as a corresponding date of publication for each publication of the subset of publications that cite to the publication being scored; and
calculating the score for the publication being scored using the determined total number of publications that cite to the publication being scored and the corresponding dates of publication for the publications of the subset of publications that cite to the publication being scored.

16. The method of claim 15, wherein calculating the score for the publication being scored further includes factoring in one or more user-provided ratings for each publication being scored.
